(19) United States
(12) Patent Application Publication
(10) Pub. No.: US 2009/0136814 A1
(43) Pub. Date: May 28, 2009

(54) FUEL CELL AND ELECTROLYTE LAYER FOR FUEL CELL

(76) Inventor: Nobuo Yodoshi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/097,816

(22) PCT Filed: Dec. 20, 2006
(86) PCT No.: PCT/JP2006/325993

§ 371 Date: Jun. 17, 2008

(30) Foreign Application Priority Data
Dec. 22, 2005 (JP) 2005-369292

(51) Int. Cl. H01M 8/10

(52) U.S. Cl. 429/30

(57) ABSTRACT

A fuel cell includes an ion-conductive electrolyte layer 20 interposed between a pair of electrodes and structured to contain a polymer electrolyte and an antifreeze protein of preventing growth of ice crystal from liquid water.

### TECHNICAL FIELD

The present invention relates to a polymer electrolyte fuel cell and an electrolyte layer included in the polymer electrolyte fuel cell.

### BACKGROUND ART

Solid polymer electrolyte membranes included as electrolyte layers in polymer electrolyte fuel cells have high proton conductivity in the wet state. In the fuel cells including the solid polymer electrolyte membranes, liquid water is produced at one of electrodes, more specifically a cathode, with progress of an electrochemical reaction. The liquid water produced in such polymer electrolyte fuel cells or the water vapor contained in a reactive gas supplied to such polymer electrolyte fuel cells may cause various troubles. For example, condensation of water in the vicinity of the electrode formed on the electrolyte membrane may interfere with the smooth gas supply to the electrode and undesirably lower the cell performance. One proposed structure of preventing the interference of the condensed water with the smooth gas flow provides a hydrophilic coating, such as protein coating, inside the fuel cells, for example, on the surface of the gas separator, so as to prevent water accumulation.

In this proposed structure of preventing accumulation of the liquid water and ensuring the smooth gas flow inside the fuel cells, however, there may be a trouble caused by freezing of the liquid water in a low temperature condition. For example, on activation of the fuel cells in the low temperature condition of or below 0° C., water produced with progress of power generation may be frozen in the electrolyte membrane. The frozen water in the electrolyte membrane interferes with migration of protons in the electrolyte membrane and thereby prevents continuation of power generation. The electrochemical reaction for power generation of the fuel cells produces heat and gradually increases the temperature of the fuel cells. Freezing of water in the electrolyte membrane immediately after the start of power generation, however, interferes with continuation of power generation and prevents the temperature increase of the fuel cells. Namely freezing of water interferes with smooth start of the fuel cells.

### SUMMARY OF THE INVENTION

In order to solve at least part of the problem arising in the prior art structure, there would be a demand for preventing deterioration of a starting performance of a fuel cell caused by freezing of liquid water in a low temperature condition.

One aspect of the invention pertains to a fuel cell including an ion-conductive electrolyte layer interposed between a pair of electrodes and structured to contain a polymer electrolyte and an antifreeze protein of preventing growth of ice crystal from liquid water.

On activation of the fuel cell in a low temperature condition that causes liquid water to be frozen, the presence of the antifreeze protein in the electrolyte layer effectively prevents freezing of water in the electrolyte layer. This arrangement desirably prevents a decrease in proton conductivity caused by freezing of water in the electrolyte layer and ensures smooth start and continuation of power generation of the fuel cell even in the low temperature condition. This arrangement also effectively protects the electrolyte layer from being damaged by freezing of water.

The technique of the invention is not restricted to the fuel cell as the above aspect of the invention but is also actualized by diversity of other aspects, for example, a manufacturing method of such a fuel cell and an antifreezing method of an electrolyte layer included in such a fuel cell on the start of the fuel cell in the low temperature condition.

### BRIEF DESCRIPTION OF THE DRAWINGS

FIG. 1 is a sectional view schematically illustrating the structure of a unit cell 10;

FIG. 2 shows a general manufacturing process of an electrolyte layer 20;

FIG. 3 is a sectional view schematically illustrating the structure of a fuel cell in a second embodiment; and

FIG. 4 is a sectional view schematically illustrating the structure of a fuel cell in a third embodiment.

### DETAILED DESCRIPTION OF THE PREFERRED EMBODIMENTS

Some aspects of carrying out the invention are described below as preferred embodiments with reference to the accompanied drawings.

### A. Structure of Fuel Cell

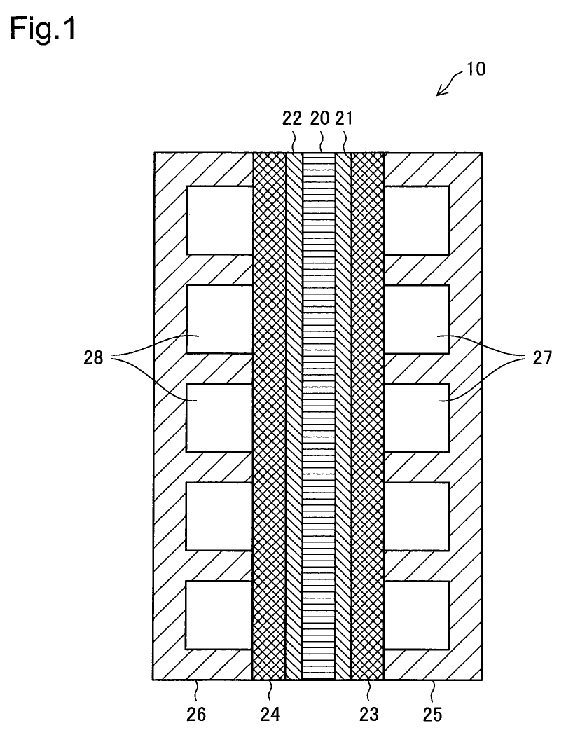

FIG. 1 is a sectional view schematically illustrating the structure of a unit cell 10 as a unit of fuel cells in a first embodiment of the invention. The unit cell 10 includes an electrolyte layer 20, an anode 21 and a cathode 22 formed as catalyst electrodes on respective faces of the electrolyte layer 20, a pair of gas diffusion layers 23 and 24 arranged across the electrolyte layer 20 with the catalyst electrodes formed thereon, and a pair of gas separators 25 and 26 arranged outside the respective gas diffusion layers 23 and 24.

The fuel cells of the embodiment are polymer electrolyte fuel cells. The electrolyte layer 20 is made of, for example, a fluororesin having a perfluorosulfonic acid group and showing good proton conductivity in the wet state. In the structure of this embodiment, the electrolyte layer 20 further includes an antifreeze protein homogeneously dispersed inside thereof. The antifreeze protein contained in the electrolyte layer 20 will be described later in detail.

Each of the anode 21 and the cathode 22 contain a catalyst metal, for example, platinum or a platinum alloy. The gas diffusion layers 23 and 24 are made of a gas-permeable electrically-conductive material, for example, carbon paper, carbon cloth, metal mesh, or metal foam. The gas diffusion layers 23 and 24 of the embodiment are both plate members having flat surface. The gas diffusion layers 23 and 24 allow passage of respective reactive gases subjected to the electrochemical reaction, while working as power collectors.

The gas separators 25 and 26 are made of a gas-impermeable, electrically-conductive material, for example, compressed carbon or stainless steel. The gas separators 25 and 26 have preset concavo-convex structures. The concavo-convex structures define an inter-unit cell fuel gas flow path 27 formed between the gas separator 25 and the gas diffusion layer 23 for the for the flow of a hydrogen-containing fuel gas, while defining an inter-unit oxidizing gas flow path 28 formed between the gas separator 26 and the gas diffusion layer 24 for the flow of an oxygen-containing oxidizing gas.

Gaskets or any other suitable seal members (not shown) are provided around the periphery of the unit cell 10 to ensure the sufficient sealing property in the inter-unit cell fuel gas flow path 27 and the inter-unit cell oxidizing gas flow path 28. The fuel cells of the embodiment have a stack structure of multiple unit cells 10. Multiple gas manifolds (not shown) are provided around the periphery of the stack structure of the fuel cells in parallel to the laminating direction of the unit cells 10 to allow passage of the fuel gas and the oxidizing gas. The fuel gas is introduced through a fuel gas supply manifold among the multiple gas manifolds, is distributed into the respective unit cells 10, flows through the respective inter-unit cell fuel gas flow paths 27 with being subjected to the electrochemical reaction, and joins together again to be discharged through a fuel gas exhaust manifold. Similarly the oxidizing gas is introduced through an oxidizing gas supply manifold, is distributed into the respective unit cells 10, flows through the respective inter-unit cell oxidizing gas flow paths 28 with being subjected to the electrochemical reaction, and joins together again to be discharged through an oxidizing gas exhaust manifold.

### B. Anti-Freezing of Electrolyte Layer by Antifreeze Protein

The antifreeze protein (AFP) represents proteins adsorbing on the surface of ice crystals (ice nuclei) in a low temperature condition of or below 0° C. and interfering with the growth of the ice crystals in a specific direction, thereby preventing freezing of an aqueous solution. The adsorption of the antifreeze protein changes the growth shape of the ice crystals from hexagonal crystals to bipyramid crystals and stops the growth of the ice crystals in this shape, thus preventing freezing of the whole aqueous solution. As is known in the art, such antifreeze proteins are observed in various fish, coleopterans, plants, fungi, and bacteria. A typical example of the antifreeze protein is a glycoprotein having tripeptide consisting of the repeated structure of alanine-threonine-alanine and glycopeptide consisting of N-acetylgalactosamine-galactose disaccharide. Selection of the antifreeze protein and the setting of the operating temperature of the fuel cells should be determined by taking into account the stability of the antifreeze protein. The antifreeze protein of this embodiment may be a mixture of multiple different antifreeze proteins. The antifreeze protein used in this embodiment may be a purified substance derived from a natural product of, for example, fish or may alternatively be an artificially synthesized substance.

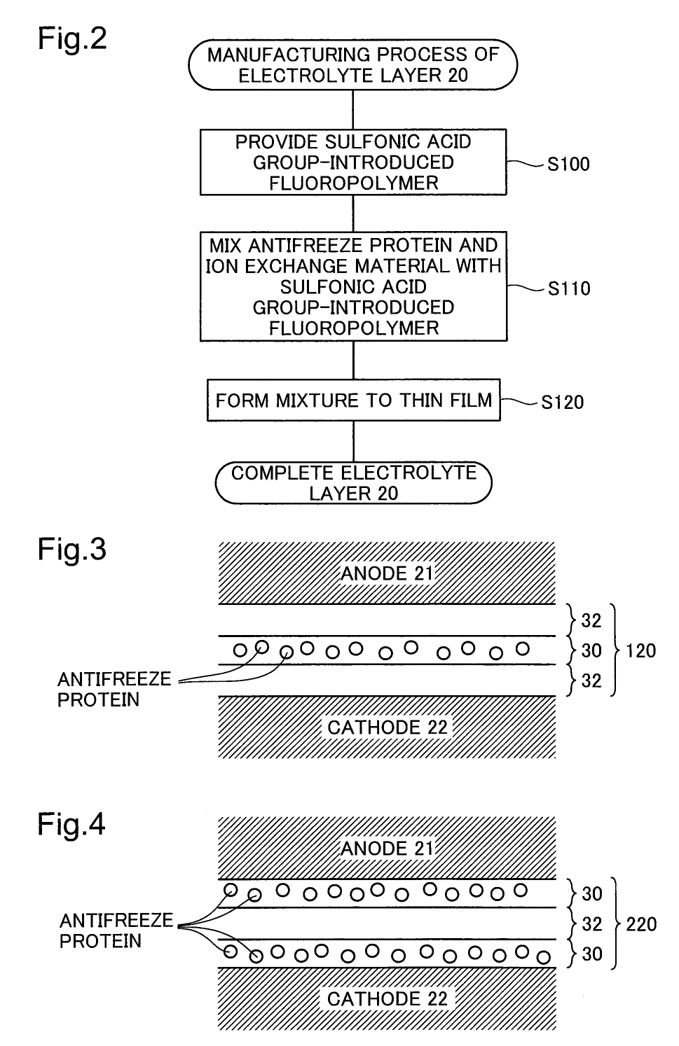

FIG. 2 shows a general manufacturing process of the electrolyte layer 20. The procedure of the embodiment premixes the antifreeze protein with the material of a solid polymer electrolyte membrane and forms a thin film of the mixture to produce the antifreeze protein-containing solid polymer electrolyte membrane. The general manufacturing process of the electrolyte layer 20 first provides a sulfonic acid group-introduced fluoropolymer (step S100). The sulfonic acid group-introduced fluoropolymer is obtained by introducing the sulfonic acid group into fine particles of fluoropolymer with the particle diameter in the range of 0.1 to 100 μm by radiation graft polymerization. The fluoropolymer may be, for example, any single one or any combination of polytetrafluoroethylene (PTFE), tetrafluoroethylene-perfluoroalkylvinyl ether copolymer (PFA), tetrafluoroethylene-hexafluoropropylene copolymer (FEP), tetrafluoroethylene-ethylene copolymer (ETFE), polyvinylidene fluoride (PVDF), polychlorotrifluoroethylene (PCTFE).

The sulfonic acid group-introduced fluoropolymer provided at step S100 is mixed with the antifreeze protein and anion exchange material (step S110). The ion exchange material may be any single one or a combination of perfluorosulfonic acid polymer and perfluorocarboxylate polymer. The perfluorosulfonic acid polymer may be prepared, for example, by copolymerizing tetrafluoroethylene with fluorosulfonyl group-containing perfluorovinyl ether and hydrolyzing the copolymer. The perfluorocarboxylate polymer may be prepared, for example, by copolymerizing tetrafluoroethylene with carboxylic acid group-containing perfluorovinyl ether and hydrolyzing the copolymer. The antifreeze protein may be in a powdery form or in a liquid form. The procedure of step S110 dissolves the ion exchange material into a selected solvent and homogeneously disperses the antifreeze protein and the fluoropolymer provided at step S100 into the solution.

The dispersion mixture prepared at step S110 is formed to a thin film (step S120) to complete the electrolyte layer 20. The formation may be, for example, pours the dispersion mixture prepared at step S110 homogenously into a flat mold to form a thin film, dries and solidifies the thin film of the dispersion mixture at 50° C., and peels the dried thin film off the mold. The resulting electrolyte layer 20 has a thickness of, for example, 10 to 100 μm.

In the case of activation of the fuel cells in the low temperature condition of or below 0° C. to start power generation, water is produced at the cathode 22 to gradually increase the water content of the electrolyte layer 20. In the structure of the fuel cells of the embodiment, the presence of the antifreeze protein in the electrolyte layer 20 prevents freezing of the water content in the electrolyte layer 20. This arrangement desirably allows continuous migration of protons in the electrolyte layer 20, which is interfered with by freezing of water in the electrolyte layer 20, and accordingly prevents a decrease in proton conductivity of the electrolyte layer 20 by freezing of water. Namely the presence of the antifreeze protein ensures smooth start and continuation of power generation of the fuel cells even in the low temperature condition. The smooth continuation of power generation gradually increases the temperature of the fuel cells and keeps the fuel cells in the stationary state.

On activation of the fuel cells in the low temperature condition, water frozen in the electrolyte layer 20 may cause a stress in the electrolyte layer 20 and damage the electrolyte layer 20. In the fuel cells of the embodiment, however, the presence of the antifreeze protein in the electrolyte layer 20 effectively interferes with the growth of ice crystals in the electrolyte layer 20 and disperses and controls the stress caused by freezing of water, thus desirably protecting the electrolyte layer 20 from being damaged by freezing of water.

The introduction of the sulfonic acid group into the fluoropolymer by radiation graft polymerization may be performed at various stages of the manufacturing process, for example, even after formation of the thin film. The addition of the antifreeze protein after the introduction of the sulfonic acid group into the fluoropolymer by radiation graft polymerization as described above in this embodiment, however, preferably controls deterioration of the antifreeze protein caused by the chemical reaction or the thermal reaction.

In the fuel cells of the first embodiment, the manufacturing process of the electrolyte layer 20 mixes the ion exchange material with the fluoropolymer having the sulfonic acid group introduced by radiation graft polymerization. This composition is, however, not restrictive but may be modified in various ways. For example, as long as the sufficient strength of the electrolyte layer 20 is assured, the electrolyte layer 20 may be prepared by mixing only the ion exchange material with the antifreeze protein without adding the fluoropolymer with the sulfonic acid group introduced by radiation graft polymerization.

### C. Second Embodiment

In the fuel cells of the first embodiment, the antifreeze protein is homogeneously dispersed in the electrolyte layer 20. In one modification, the antifreeze protein may be present only in a specific partial area of the electrolyte layer. One example of this modified structure is described below as a second embodiment.

FIG. 3 is a sectional view schematically illustrating the structure of a fuel cell in the second embodiment. The fuel cell of the second embodiment has the similar structure to that of the fuel cell of the first embodiment, except that the electrolyte layer 20 is replaced with an electrolyte layer 120. The like elements are expressed by the like numerals and are not specifically explained here. The enlarged sectional view of FIG. 3 shows only the neighborhood of the electrolyte layer 120.

In the fuel cells of the second embodiment, the electrolyte layer 120 includes an antifreeze protein-containing layer 30 having the antifreeze protein content and a pair of antifreeze protein-free layers 32 being free of the antifreeze protein and arranged across the antifreeze protein-containing layer 30. The antifreeze protein used in the second embodiment may be any of various proteins as explained in the first embodiment.

One manufacturing process of the electrolyte layer 120 included in the fuel cells of the second embodiment first provides the antifreeze protein-containing layer 30 according to the general flow of FIG. 2 in the same manner as the electrolyte layer 20 of the first embodiment. The manufacturing process subsequently forms the antifreeze protein-free layers 32 of a solid polymer electrolyte on the respective faces of the antifreeze protein-containing layer 30 to prepare the electrolyte layer 120. The antifreeze protein-free layers 32 may be formed by, for example, applying a solution of the ion exchange polymer material, which is used for preparation of the electrolyte layer 20 in the first embodiment, on the respective faces of the antifreeze protein-containing layer 30 and drying and solidifying the applied solution.

Another manufacturing process of the electrolyte layer 120 shown in FIG. 3 provides two antifreeze protein-free solid polymer electrolyte membranes as the pair of antifreeze protein-free layers 32 separately from the antifreeze protein-containing layer 30 and bonds the pair of antifreeze protein-free layers 32 to the respective faces of the antifreeze protein-containing layer 30. Still another manufacturing process of the electrolyte layer 120 provides two antifreeze protein-free solid polymer electrolyte membranes as the pair of antifreeze protein-free layers 32, mixes the antifreeze protein with the ion exchange material to yield an ion-conductive paste, and joins the pair of antifreeze protein-free layers 32 together via the ion-conductive paste as an adhesive. The antifreeze protein-containing paste is dried and solidified to form the antifreeze protein-containing layer 30 between the pair of antifreeze protein-free layers 32. After formation of the electrolyte layer 120, the catalyst electrodes are formed on the respective faces of the electrolyte layer 120, and the pair of gas diffusion layers 23 and 24 and the pair of gas separators 25 and 26 are sequentially arranged across the electrolyte layer 120 to complete the assembly of the fuel cells in the same manner as the first embodiment.

In the fuel cells of the second embodiment, the electrolyte layer 120 includes the antifreeze protein-containing layer 30 having the antifreeze protein content. On activation of the fuel cells even in the low temperature condition, this structure effectively prevents the water content in the electrolyte layer 120 from being frozen and ensures smooth start and continuation of power generation. This structure also desirably protects the electrolyte layer 120 from being damaged by freezing of water in the electrolyte layer 120.

### D. Third Embodiment

In the structure of the second embodiment, the antifreeze protein-containing layer 30 is located in the middle of the electrolyte layer 120. In one modification, the antifreeze protein-containing layer may be provided on at least one surface of the electrolyte layer. One example of this modified structure is described below as a third embodiment. FIG. 4 is a sectional view schematically illustrating the structure of a fuel cell in the third embodiment. The fuel cell of the third embodiment has the similar structure to that of the fuel cell of the second embodiment, except that the electrolyte layer 120 is replaced with an electrolyte layer 220 having a different layout of the antifreeze protein-containing layer 30 and the antifreeze protein-free layer 32. The like elements are expressed by the like numerals and are not specifically explained here. Like FIG. 3, the enlarged sectional view of FIG. 4 shows only the neighborhood of the electrolyte layer 220.

In the fuel cells of the third embodiment, the electrolyte layer 220 includes antifreeze protein-containing layers 30 on the respective faces of one antifreeze protein-free layer 32. The antifreeze protein used in the third embodiment may be any of various proteins as explained in the first embodiment.

One manufacturing process of the electrolyte layer 220 included in the fuel cells of the third embodiment first provides the antifreeze protein-free layer 32. The antifreeze protein-free layer 32 may be prepared according to some modification of the general flow of FIG. 2, for example, by forming a thin film from the mixture of only the fluoropolymer and the ion exchange material obtained without addition of the antifreeze protein at step S110 or by forming a thin film from the ion exchange material alone. Another procedure of preparing the antifreeze protein-free layer 32 may form a thin film of the fluoropolymer material, for example, copolymer of tetrafluoroethylene and fluorosulfonyl group-containing perfluorovinyl ether, by extrusion and hydrolyze the thin film of the copolymer. Still another procedure of preparing the antifreeze protein-free layer 32 may irradiate a thin film of the fluoropolymer material, for example, ethylene-tetrafluoroethylene copolymer (ETFE), to produce radicals in the whole polymer thin film and cause reaction of a styrene base material, for example, trifluorostyrene (TFS), and sulfonate the thin film to give a radiation graft polymer membrane.

Any of various methods may be adopted to fix the antifreeze protein and form the antifreeze protein-containing layer 30 on the antifreeze protein-free layer 32 as the solid polymer electrolyte membrane. One available method may mix the antifreeze protein with an adequately selected photosensitive resin (photopolymerizer), apply the mixture onto the antifreeze protein-free layer 32, and solidify the photosensitive resin with laser or X ray to form the antifreeze protein-containing layer 30. Selection of the adequate photosensitive resin and setting of the thickness of the resulting antifreeze protein-containing layer 30 should be determined by taking into account the influence of the presence of the antifreeze protein on the overall ion conductivity of the whole electrolyte layer 220. Another available method may mix the antifreeze protein with the ion exchange material to give a slurry, apply the slurry onto the antifreeze protein-free layer 32, and dry and solidify the slurry to form the antifreeze protein-containing layer 30 on the antifreeze protein-free layer 32.

Another manufacturing process of the electrolyte layer 220 shown in FIG. 4 provides two antifreeze protein-containing solid polymer electrolyte membranes as the pair of antifreeze protein-containing layers 30 separately from the antifreeze protein-free layer 32 and bonds the pair of antifreeze protein-containing layers 30 to the respective faces of the antifreeze protein-free layer 32. Still another manufacturing process of the electrolyte layer 220 provides two antifreeze protein-containing solid polymer electrolyte membranes as the pair of antifreeze protein-containing layers 30 according to the general flow of FIG. 2, provides an ion-conductive paste of the ion exchange material, and joins the pair of antifreeze protein-containing layers 30 together via the ion-conductive paste as an adhesive. The ion-conductive paste is dried and solidified to form the antifreeze protein-free layer 32 between the pair of antifreeze protein-containing layers 30 and give the electrolyte layer 220. After formation of the electrolyte layer 220, the catalyst electrodes are formed on the respective faces of the electrolyte layer 220, and the pair of gas diffusion layers 23 and 24 and the pair of gas separators 25 and 26 are sequentially arranged across the electrolyte layer 220 to complete the assembly of the fuel cells in the same manner as the first and the second embodiments.

In the structure of the fuel cells of the third embodiment, the electrolyte layer 220 includes the antifreeze protein-containing layers 30 having the antifreeze protein content and accordingly has the similar effects to those of the first embodiment and the second embodiment explained above.

### E. Other Aspects

The embodiments discussed above are to be considered in all aspects as illustrative and not restrictive. There may be many modifications, changes, and alterations without departing from the scope or spirit of the main characteristics of the present invention. Some examples of possible modification are given below.

(1) In the fuel cells of the first through the third embodiments, the fluoropolymer is adopted as the polymer electrolyte material of the electrolyte layer. The fluoropolymer is, however, not essential but the electrolyte layer may be made of a hydrocarbon polymer electrolyte material. The antifreeze protein content in the solid polymer electrolyte layer of the hydrocarbon polymer material having water-absorbing property and ion conductivity in the wet state has the similar effects to those described previously.

(2) In the fuel cells of the second and the third embodiments, the electrolyte layer has the three-layer structure of the antifreeze protein-containing layer 30 and the antifreeze protein-free layer 32. The three-layer structure is, however, not essential but the electrolyte layer may have a different number of layers, which may have different characteristics on the antifreeze protein or the electrolyte. The characteristics to be differed may be, for example, the presence or the absence of the antifreeze protein, the content of the antifreeze protein, and the type of the antifreeze protein, as well as the type of the electrolyte, that is, the type of the polymer electrolyte material (for example, a fluoropolymer or a hydrocarbon polymer). The respective layers of the electrolyte layer may include polymer electrolytes prepared by different techniques (for example, a polymer with sulfonic acid group introduced by graft polymerization, a polymer with sulfonic acid group introduced by hydrolysis of a selected copolymer, and a polymer formed to a thin film after introduction of sulfonic acid group to a polymer material or a polymer with sulfonic acid group introduced after formation of a polymer material to a thin film). The laminated arrangement of the multiple layers is not essential, but the electrolyte layer may be divided into multiple areas on the planar surface of the electrolyte layer. These multiple areas may also have different characteristics on the antifreeze protein or the electrolyte.

In the structure of dividing the electrolyte layer into multiple areas having different characteristics, for example, the content of the antifreeze protein may be increased in a specific area expected to have the greater effects by addition of the antifreeze protein, compared with the contents in the other areas. This arrangement ensures the sufficient antifreezing effect as the whole electrolyte layer, while restricting the influence of the presence of the antifreeze protein on the strength and the ion conductivity of the electrolyte layer. The respective areas may have different characteristics on the electrolyte, for example, the ion conductivity, strength, thermal resistance, oxidation resistance, and hydrolysis resistance, according to the local environments of these areas. This arrangement desirably enhances the performance of the whole electrolyte layer.

(3) The principle of the present invention is not restricted to the structure of the fuel cells shown in FIG. 1 but is applicable to fuel cells having any other suitable structures. For example, the gas separators having the concavo-convex structures to define the inner-unit cell gas flow paths may be replaced with gas separators having flat surfaces. In this modified structure, an electrically-conductive porous member having gas permeability like the gas diffusion layers 23 and 24 is provided as a gas flow path-forming member between each combination of the electrode and the gas separator. The cavities formed inside of the electrically-conductive porous members form the inner-unit cell gas flow paths. The presence of the antifreeze protein in the electrolyte layer ensures the similar effects to those described above in the fuel cells of any structure having various arrangements of gas diffusion layers and gas separators.

What is claimed is:

1. A fuel cell, comprising:
an ion-conductive electrolyte layer interposed between a pair of electrodes and structured to contain a polymer electrolyte and an antifreeze protein of preventing growth of ice crystal from liquid water.

2. The fuel cell in accordance with claim 1, wherein the antifreeze protein is substantially homogeneously dispersed in the electrolyte layer.

3. The fuel cell in accordance with claim 1, wherein the antifreeze protein is present in a specific area among multiple areas as divisions of the electrolyte layer.

4. The fuel cell in accordance with claim 3, wherein the specific area is a laminated area as a division of the electrolyte layer divided parallel to a planar surface of the electrolyte layer.

5. The fuel cell in accordance with claim 3, wherein the specific area is a divisional area among multiple divisional areas of the electrolyte layer divided on a planar surface of the electrolyte layer.

6. The fuel cell in accordance with claim 1, wherein the electrolyte layer includes multiple layers having different contents of the antifreeze protein.

7. The fuel cell in accordance with claim 1, wherein the electrolyte layer includes multiple layers having different types of the antifreeze protein.

8. The fuel cell in accordance with claim 6 or 7, wherein the respective layers of the electrolyte layer are made of electrolytes having different characteristics.
